(19) United States
(12) Patent Application Publication
(10) Pub. No.: US 2012/0312012 A1
(43) Pub. Date: Dec. 13, 2012

(54) MULTISTAGE CHARGING SYSTEM FOR AN INTERNAL COMBUSTION ENGINE

(76) Inventors: Andreas Thoss, Markdorf (DE); Ronald Hegner, Friedrichshafen (DE)

(21) Appl. No.: 13/473,151

(22) Filed: May 16, 2012

Related U.S. Application Data
(63) Continuation-in-part of application No. PCT/EP2010/006964, filed on Nov. 16, 2010.

(30) Foreign Application Priority Data
Nov. 20, 2009 (DE) 10 2009 046 940.0

(51) Int. Cl. F02B 37/18; F02B 33/00

(52) U.S. Cl. 60/605.2; 60/612

(57) ABSTRACT

In a multi-stage charging group for receiving an operating fluid of an internal combustion engine which includes a first and a second turbocharger with a first and, respectively, a second turbine arranged in a common support housing, a bypass guide structure is provided in the support housing for guiding the operating fluid around the first turbine, which guide structure is formed at least partially by the support housing and a housing section of the first turbine.

This is a continuation-in-part application of pending international patent application PCT/EP2010/006964 filed Nov. 16, 2010 and claiming the priority of German patent application 10 2009 046 940.0 filed Nov. 20, 2009.

### BACKGROUND OF THE INVENTION

The invention resides in a multistage charging system for charging an internal combustion engine with an operating fluid comprising at least a first turbocharger with a first turbine and a second turbocharger with a second turbine wherein the first turbine and the second turbine are supported by a common support housing which includes also a bypass passage for the operating fluid extending around the first turbine and also to an internal combustion engine including such a charging system.

In connection with engines, especially high power engines and medium power engines, multistage charging has been found to be the preferred means for optimizing the power output of an internal combustion engine. Herein also the use of several parallel or multistage turbochargers has been found to be expedient. WO 2004/013472 A1 and DE 195 24 566, which are assigned to the assignee of the present application and which disclose an internal combustion engine with two or several parallel operating exhaust gas turbochargers arranged in a common support housing, include in each case compressors which are disposed without the support housing.

The concept of a two-stage charging is realized for example in an internal combustion engine as disclosed in EP 17 10 415 A1. In order to provide for an effective charging also in a lower power output range of an engine, a bypass arrangement for the operating fluid of the internal combustion engine bypassing the first turbine is provided. The first turbine is a high pressure turbine and the second turbine is a low pressure turbine. In a charging group as shown in FIG. 3 of EP 1 710 415 A1, a low pressure exhaust gas turbine is provided with a double gas inlet, that is two gas inlets, wherein one of the two gas inlets is supplied with exhaust gas from the exhaust gas outlet of the turbine of the high pressure turbocharger, whereas the other gas inlet is supplied with exhaust gas from the supply line leading to the exhaust gas inlet of the turbine of the high pressure turbocharger via a throttle element. Such a local and separate gas supply to the low pressure turbine, closely downstream of the high pressure turbine causes the low pressure turbine to be only partially charged which detrimentally affects the turbine operating efficiency.

DE 100 27 668 A1 discloses a throttling element.

The two-stage charging in connection with the large engines manufactured by the Assignee has been found to be particularly effective. In DE 10 2007 046 A1 of the assignee of the present application, a two-stage charging group is described which largely overcomes the problems associated with partial charging in that a calming section is provided between the fluid discharge of the high-pressure turbine and fluid inlet of the low pressure turbine in a space-saving manner. To this hand, also an admixture line can be formed so as to have a low flow resistance.

In an advantageous alternative embodiment a partial charging of a second turbine, particularly in connection with the use of a bypass flow is generally avoided in order, among others, to obtain a better efficiency of a charging group.

It is accordingly the object of the present invention to provide a multistage charging group and an internal combustion engine which achieves a comparably good efficiency also in connection with a bypass flow. In particular, the disadvantages of a partial charging of the second turbine by exhaust gas bypassing the first turbine of the charging group should be avoided. In particular, the second turbine should be operated in a flow-optimized manner when the first turbine is bypassed by the exhaust gas flow.

### SUMMARY OF THE INVENTION

In a multi-stage charging group for receiving an operating fluid of an internal combustion engine which includes a first and a second turbocharger with a first and, respectively, a second turbine arranged in a common support housing, a bypass guide structure is included in the support housing for guiding the operating fluid around the first turbine, which guide structure is formed at least partially by the support housing and a housing section of the first turbine.

The invention is based on the consideration that, with the first turbine and the second turbine being supported in a common support housing, there is a good chance to avoid an only local partial charging of the second turbine. With the arrangement according to the invention a supply path to the second turbine is quite space-saving. In a common support housing of the first and the second turbine, a particularly advantageous flow guide arrangement for guiding the bypass flow. As a result, the bypass flow guide structure is formed at least partially within the support housing. In other words, a bypass volume of the operating fluid is conducted at least partially along the support housing, in particular, along a wall of the support housing. In accordance with the invention, the support housing is utilized not only in connection with the usual functions, that is, for supporting and accommodating the first turbine and the second turbine. In addition, the support housing is also used for conducting a bypass volume of operating fluid in the bypass guide structure within the support housing that is through a bypass passage surrounded and formed by the support housing.

Under the term of accommodating the first turbine and the second turbine in the support housing, it should be understood that essential parts, especially a turbine wheel, is arranged within the interior space of the support housing.

In principle, it is achieved that—even when the bypass passage is used—the overall amount of operating fluid is conducted through, and past, the arrangement of the first turbine, that is, the main amount of the operating fluid is conducted through the first turbine and the bypass amount is conducted via the bypass passage around the first turbine within the support housing. The main amount and the bypass amount of the operating fluid are conducted practically next to each other preferably separated by the wall of the housing of the first turbine.

The total amount of the operating fluid conducted to the second turbine is conducted in this way in a space-saving manner uniformly and with a comparatively low flow resistance. It is in particular possible to uniformly supply the operating fluid to the second turbine. A low flow resistance and practically unidirectional flow admission to the second turbine is achieved. This results in a noticeable increase in the overall efficiency of the multi-stage charging group. In a preferred embodiment of the wall of the bypass guide structure is formed at least partially by a wall of the support housing. Preferably, the wall of the bypass guide structure is additionally formed partially by the wall of the turbine housing of the first turbines. Basically also another wall may be used for that purpose in the interior space surrounded by the support housing. Advantageously, the wall of the support housing and the wall of the turbine housing and/or another wall in the interior space form opposite wall parts of the bypass guide structure. In this way, the operating fluid is guided between these wall parts—that is, for example between a wall of the support housing and a wall of the turbine housing of the first turbine—and in direct contact with the wall parts.

The concept of the invention has been found to be particularly advantageous for a charging group, in which the first turbocharger is part of a high pressure stage. The second turbocharger is preferably part of the low pressure stage. Basically, the charging group may include further pressure stages. The above concept is not limited to a different pressure design of the first turbine and the second turbine but is considered to be advantageous for the above-described embodiment.

Preferably, the first turbocharger includes a high pressure compressor and the second turbocharger a low pressure compressor wherein the high pressure compressor and the low-pressure are arranged outside the support housing. This has been found to be particularly expedient with respect to the flow guide arrangement.

The support housing may be a multi-wall or single-wall housing. That is, the support housing is preferably gas-tight for conducting a bypass flow of the operating fluid. At least one of the walls of the support housing should be gas-tight.

Advantageously, a bypass guide structure may have, within the support housing, a cross-section which increases along the length thereof. This contributes to a uniform admission of the flow to the second turbine at the exit end of the bypass guide structure. A widening of the cross-section can be achieved for example by increasing the distance between wall parts of the bypass guide structure.

In a preferred embodiment, an operating fluid guide structure between the first turbine and the second turbine includes an admission housing. The admission housing is arranged in a flow guide section preferably within the support housing. In a particular embodiment, the admission housing extends around an inlet area of the first turbine.

In a further embodiment, the admission housing has at its entrance area a circular cross-section for receiving the operating fluid from the bypass guide structure which circular cross-section is greater than the discharge cross-section of the first turbine. The circular cross-section extends around the discharge cross-section, that is, preferably separated only by the turbine housing of the first turbine. A bypass amount of the operating fluid can in this way be conducted to the admission housing with comparatively little flow resistance together with the main fluid flow—practically in side-by-side relationship. In a particularly preferred embodiment, the admission housing surrounds initially a supply flow section of the second turbine. In particular, an outlet end flow cross-section of the admission housing corresponds to the supply cross-section of the second turbine. The cross-sections are advantageously annular cross-sections.

Overall, a space consuming, completely separate bypass guide structure or, respectively, a local admission down-stream of the high pressure turbine of a bypass flow for the operating fluid is superfluous with the concept described herein, so that also the initially mentioned disadvantages are avoided. Rather, the concept according to the invention, in particular with the modifications mentioned above, results in a uniform and low-resistance flow guide arrangement for most of the operating fluid as well as the bypass amount of the operating fluid and in a uniform admission of the fluid to the second turbine during bypass operation and operation of the first turbine under full load.

Concerning the admission of the operating fluid to the charging group, in a preferred embodiment of the invention, fluid supply is provided on one hand to the first turbine and to the bypass flow passage on the other hand. These flows can advantageously be conducted in the immediate admission area to the first turbine for example in an admission connection almost in a parallel flow pattern with comparatively low flow resistance. The bypass flow supply passage may include a control member for controlling the bypass flow volume of the operating fluid. The control member is preferably a throttle valve. Altogether, the concept of the invention has been found to be particularly advantageous for a charging group with a first turbine in the form of a radial turbine and a second turbine in the form of an axial turbine. Such a combination of first and second turbines can be effectively accommodated in a common support housing in a particularly space-saving manner with comparably low flow losses.

It is therefore also an object of the present invention to provide a multi-stage charging system for charging an internal combustion engine of the type disclosed above which is highly efficient and requires relatively little space and which is operated by the exhaust gas of an internal combustion engine. The charging system should also incorporate exhaust gas recirculation, a charge air intake system and a heat exchanger, particularly in connection with a multi-stage charging group.

Exemplary embodiments of the invention will be described below with reference to the accompanying drawings. The exemplary embodiments are not shown according to scale; rather, the drawings are only of explanatory nature and provided to show the invention schematically. It is to be taken into consideration that many modifications and changes with regard to form and details of an embodiment are possible without departure from the concept of the invention. The features disclosed in the description and the drawings may be essential for the further development of the invention individually as well as in combination. All combinations of at least two of the features disclosed in the description, the drawings or the claims are considered to be within the frame of the present invention. The general concept of the invention is not limited to the exact form or detail of the preferred embodiment as shown and described below or limited to a subject which would be limited in comparison to the subject as defined in the claims. With dimensional ranges also values within the mentioned limits may be selected as limit values and claimed as such.

For simplicity reasons, identical or similar components or components or components with identical or similar functions are designated by the same reference numerals.

Further advantages and features of the invention will become apparent from the following description of preferred embodiments on the basis of the accompanying drawings.

### BRIEF DESCRIPTION OF THE DRAWINGS

FIG. 1A is a partial sectional view of a preferred embodiment of a two-stage charging group with a high-pressure stage and a low-pressure stage, and

FIG. 1B is a sectional view taken along lines B-B of FIG. 1A showing an inlet guide structure to the charging group.

### DESCRIPTION OF A PARTICULAR EMBODIMENT

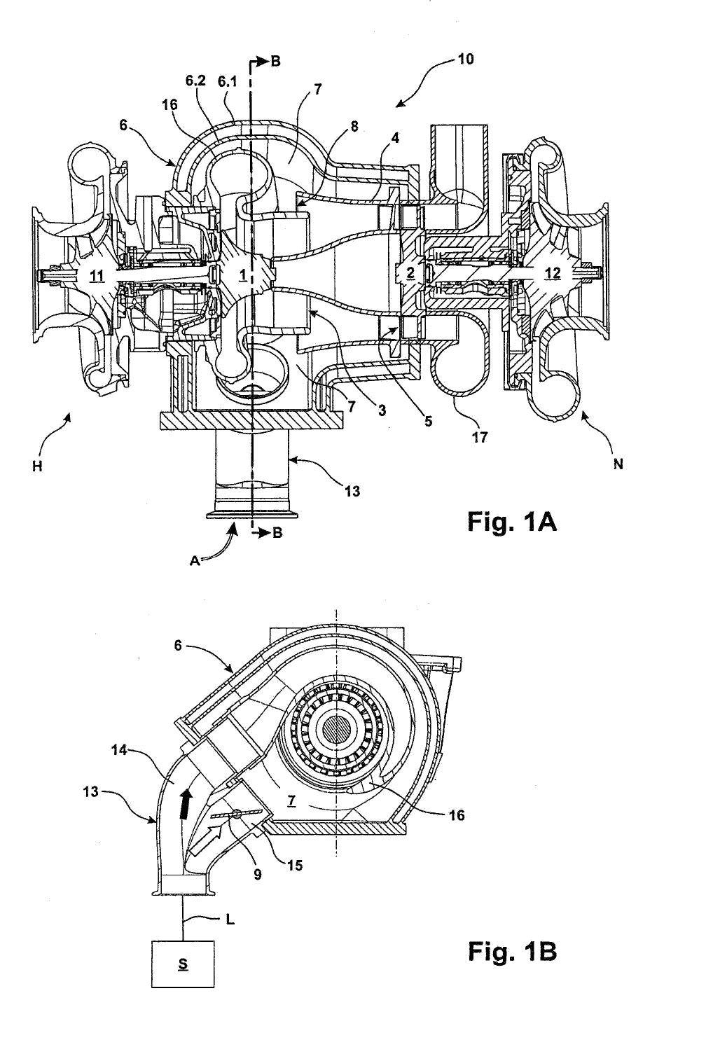

The charging group as shown in FIG. 1A includes an arrangement of two exhaust gas turbochargers disposed in a high pressure stage H and in a low pressure stage N. A first turbine 1 (below called high pressure turbine) of the high pressure stage H is in the form of a radial turbine and a second turbine 2 (below called low pressure turbine 2) of the low pressure stage N is in the form of an axial turbine for receiving exhaust gas of an internal combustion engine which is not shown. The high pressure turbine 1 includes a turbine housing 16 and the low pressure turbine 2 includes a turbine housing 17. In addition to the high pressure- and low pressure turbines 1, 2, the charging group 10 of FIG. 1 includes a high pressure compressor 11 with a corresponding compressor wheel and housing (not shown) and a low pressure compressor with a corresponding compressor wheel in a compressor housing (not shown). The compressor 11 is part of the high pressure stage H. The compressor 12 is part of the low pressure stage N.

As shown in FIG. 13, an operating fluid A in the form of exhaust gas is supplied via a symbolically shown exhaust gas line L of a symbolically shown charging system of an internal combustion engine to the inlet stub 13 of the high pressure turbine 1. The flow pattern of the operating fluid in the charging group 10 is indicated by the dark error. The dark error also indicates the flow of the main amount of the operating fluid for the case in which the bypass guide structure is utilized. The operating fluid or, respectively, the main amount of the operating fluid leaves the high pressure turbine 1 via an outlet opening 3 arranged downstream of the high pressure turbine along the common axis of the high and low pressure turbines 1, 2 and is then conducted in an admission housing 4 to an annular inlet passage 5 of the low pressure turbine 2. The admission housing 4 initially surrounds the outlet opening 3 of the high pressure turbine 1 and has at its outlet end a diameter corresponding to the inlet cross-section 5 of the low pressure turbine 2. The high pressure turbine 1 and the low pressure turbine 2 are arranged in a common support housing 6, which, additionally, forms a bypass guide structure 7. The bypass flow volume of the operating fluid A through the bypass guide structure 7 is shown in FIG. 1B by the light arrow.

The admission housing 4 has an annular cross-sectional area 8 which is disposed upstream of the high pressure turbine at the inlet side thereof and additionally partially overlaps the outlet flow cross-section of the high-pressure turbine 1.

In the shown embodiment, the support housing 6 includes two walls defining a flow passage, that is, an outer wall 6.1 and an inner wall 6.2. The support housing 6 is gas-tight.

The downstream flow cross-section of the gas tight chamber forming the bypass passage 7 between the wall 6.2 and the turbine housing 16 of the first turbine 1 is essentially divided by the admission housing 4. In other words, the admission housing 4 surrounds with a widened inlet opening first the outlet end of the inner turbine housing 16 which is shown as integral part of the turbine housing. In the area of the outlet of the high pressure turbine 1, there is first the wall of the admission housing 4 forming the annular cross-sectional area 8. Further, radially outwardly the inner wall 6.2 of the support housing 6 is arranged.

The admission of an operating fluid or, respectively, a major part of the operating fluid (dark arrow in FIG. 1B) and, respectively, a bypass amount of the operating fluid (light arrow in FIG. 1B) is controlled by a control member 9, which is shown in the figure as a control flap but may be any type of control valve. The control member 9 is arranged in a branch of an exhaust gas line L which splits up Y-like in a supply stub 13 immediately ahead of the inlet-side entrance of the bypass guide structure 7. The supply stub 13 has a turbine supply section 14 and a bypass supply section 15. With the control member 9 closed, only the exhaust gas flow in accordance with the dark arrow is provided for the operating fluid A. With the control member open, the main part of the operating fluid follows the path indicated by the dark arrow and the bypass amount of the operating fluid follows the path indicated by the light arrow along the bypass guide structure.

In summary, the invention resides in a multistage charging group 10 operated by an operating fluid that is an exhaust gas of an internal combustion engine, the charging group including at least a first turbocharger and a second turbocharger wherein a first turbine 1 of the first turbocharger and a second turbine 2 of the second turbocharger are arranged in a common support housing 6 together with a bypass guide structure 7 for the operating fluid for bypassing the first turbine 1. The bypass guide structure 7 is provided within, and at least partially formed by, the support housing 6, that is in the arrangement as shown in the figures, between the support housing 6 and the turbine housing 16 of the high pressure turbine.

Listing of Reference Numerals

| | |
|---|---|
| 1 | First turbine - high pressure turbine |
| 2 | Second turbine - low pressure turbine |
| 3 | Outlet end |
| 4 | Admission channel |
| 5 | Admission channel cross-section |
| 6 | Support housing |
| 6.1 | Outer wall of support housing |
| 6.2 | Inner wall of support housing |
| 7 | Bypass guide structure |
| 8 | Annular cross-section |
| 9 | Control member |
| 10 | Charging group |
| 11 | High pressure compressor |
| 12 | Low pressure compressor |
| 13 | Inlet stub |
| 14 | Turbine supply section |
| 15 | Bypass |
| 16 | First turbine housing |
| 17 | Second turbine housing |
| A | Operating fluid |
| H | High pressure stage |
| L | Exhaust line |
| N | Low pressure stage |
| S | Charging system |

What is claimed is:

1. A multistage charging group (10) for receiving an operating fluid (A) of an internal combustion engine, comprising:
a first turbocharger with a first turbine (1) and a second turbocharger with a second turbine (2),
a common support housing (6) accommodating the first turbine (1) and the second turbine (2) and including
a bypass guide structure (7) for the operating fluid (A) for guiding operating fluid A around the first turbine (1), the bypass guide structure being disposed within and at least partially formed by, the support housing (6).

2. The multi-stage charging group according to claim 1, wherein the first turbocharger is part of a high pressure stage (H) and the second turbocharger is part of a low-pressure charging stage (N).

3. The multi-stage charging group according to claim 1, wherein a wall of the bypass guide structure 47) is formed by a wall (6.2) of the support housing (6) and a wall of the turbine housing (16) of the first turbine (1).

4. The multi-stage charging group according to claim 1, wherein the support housing is gas tight.

5. The multi-stage charging group according to claim 1, wherein the first turbocharger includes a high pressure compressor (11) and the second turbocharger includes a low pressure compressor (12), both compressors (11, 12) being arranged outside support housing (6).

6. The multi-stage charging group according to claim 1, wherein an operating fluid admission channel (4) extends between the first turbine (1) and the second turbine (2) for guiding the operating fluid to the second turbine and includes an end section surrounding an inlet section (5) of the second turbine for guiding the operating fluid to the second turbine (2).

7. The multi-stage charging group according to claim 6, wherein the upstream end of the operating fluid admission channel (4) extends around the outlet end (3) of the first turbine (1).

8. The multi-stage charging group according to claim 6, wherein the admission channel (4) has an upstream end with an annular cross-section (8) which is larger than the outlet end (3) of the first turbine (1).

9. The multi-stage charging group according to claim 1, wherein the support housing (6) includes an inlet stub (13) for supplying operating fluid to the first turbine and a bypass supply (15) to the bypass guide structure (7).

10. The multi-stage charging group according to claim 1, wherein the inlet stub 13 includes a bypass flow supply section (15) with a control member (9) for controlling the operating fluid flow through the turbine and the flow through the bypass structure.

11. The multistage charging group according to claim 1, wherein the first turbine (1) is a radial turbine and the second turbine (2) is an axial turbine.

12. A multistage charging group (10) for receiving an operating fluid (A) of an internal combustion engine, comprising:
a first turbocharger with a first turbine (1) and a second turbocharger with a second turbine (2),
a common support housing (6) accommodating the first turbine (1) and the second turbine (2) and including
a bypass guide structure (7) for the operating fluid (A) for guiding operating fluid A around the first turbine (1), the bypass guide structure being disposed within and at least partially formed by, the support housing (6),
the charging system being connected to an internal combustion engine with an exhaust gas recirculation system a charge air intake and a heat exchanger.

13. An internal combustion engine with a multi-stage charging group (10) in accordance with claim 1.
